(19) United States
(12) Patent Application Publication
(10) Pub. No.: US 2019/0389274 A1
(43) Pub. Date: Dec. 26, 2019

(54) METHOD FOR DIGITALLY CONTROLLING A HEATING ARRANGEMENT AND THE HEATING ARRANGEMENT

(71) Applicant: Mahle International GmbH, Stuttgart (DE)

(72) Inventor: Matthias Schall, Ostfildern (DE)

(21) Appl. No.: 16/446,614

(22) Filed: Jun. 19, 2019

(30) Foreign Application Priority Data
Jun. 20, 2018 (DE) 102018210034.9

(51) Int. Cl. B60H 1/00; B60H 1/22

(52) U.S. Cl. CPC B60H 1/00064; B60H 1/00057; B60H 2001/00092; B60H 2001/0015; B60H 2001/00114; B60H 1/2225

(57) ABSTRACT

A method for digitally controlling a heating arrangement may include receiving a temperature value with a control device, the temperature value reflecting a current outside temperature. The method may also include determining via the control device, based on the received temperature value, a limit output of the heating arrangement that is smaller than a maximum output of the heating arrangement. The method may further include dividing the determined limit output into a plurality of output stages via the control device, a number of the plurality of output stages corresponding to a digital resolution of the control device. The method may additionally include controlling the heating arrangement between a minimum output and the limit output to one of the plurality of output stages.

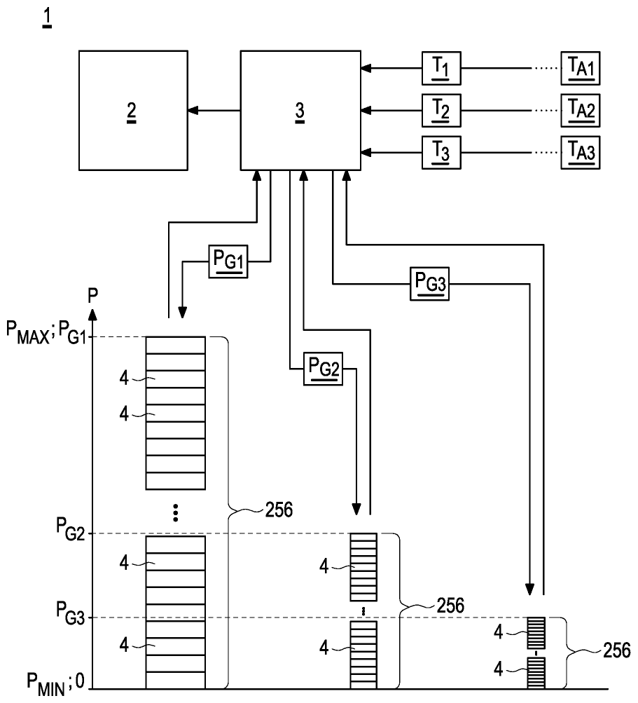

### CROSS-REFERENCE TO RELATED APPLICATIONS

This application claims priority to German Patent Application No. DE 10 2018 210 034.9, filed on Jun. 20, 2018, the contents of which is hereby incorporated by reference in its entirety.

### TECHNICAL FIELD

The invention relates to a method for digitally controlling a heating arrangement. The invention also relates to a heating arrangement for carrying out the method.

### BACKGROUND

In modern fully-electric vehicles, ever more powerful electric heaters are employed. Accordingly, PTC heaters with a heating output of up to 8 kW can be used for example for heating the vehicle cabin, the battery or the electric motor. For controlling the electric heater, a communication signal with an 8-bit resolution is usually employed in modern vehicle electrical systems, which makes possible controlling the heating output in a maximum of 256 heating stages. Because of usually required further information—such as for example diagnosis—however, the 256 stages of an 8-bit signal cannot be entirely used for controlling the heating output. For this reason, few heating stages—typically 100 to 200—are often available for controlling the heating output. The respective heating stages differ by a fixed amount of the heating output. The more powerful the electric heater is, the greater is the amount of the heating output by which two consecutive heating stages differ. In the case of a powerful electric heater, the 8-bit resolution is often no longer sufficient in order to make possible a finer control of the electric heater. This can be disadvantageous in particular in the case of higher outside temperatures. Increasing the resolution of the communication signal to 16-bit or 32-bit is often out of the question because of standardised protocols in the vehicle electrical system.

### SUMMARY

The object of the invention therefore is to state a method and a heating arrangement with which the described disadvantages are overcome.

According to the invention, this object is solved through the subject of the independent claim(s). Advantageous embodiments are subject of the dependent claim(s).

A method according to the invention is provided for digitally controlling a heating arrangement, in particular a PTC heating arrangement, for a hybrid or an electric vehicle. There, a control device of the heating arrangement receives a temperature value reflecting a current outside temperature. Dependent on the received temperature value, the control device determines a limit output of the heating arrangement which is smaller than a maximum output of the heating arrangement. The control device then divides the determined limit output into output stages, the number of which corresponds to a digital resolution of the control device. Following this, the control device controls the heating arrangement between a minimum output and the limit output to one of the output stages.

The minimum output and the maximum output of the heating arrangement are defined by their physical characteristics and cannot be changed. Accordingly, the maximum output of the heating arrangement can be between 3 kW and 8 kW. The minimum output usually corresponds to zero. In the method according to the invention, the limit output of the heating arrangement is determined dependent on the received temperature value. The limit output can be smaller by a multiple than the maximum output of the heating arrangement. The control device then divides the determined limit output into the output stages, wherein because of the output being smaller compared with the maximum output the output stages consecutively following one another differ by a comparatively smaller value. Because of this, the heating arrangement can be more accurately controlled without the digital resolution of the heating arrangement having to be changed. Advantageously, the control device can divide the determined limit output of the heating arrangement into a maximum of 256 output stages corresponding to a digital resolution of 8-bit.

In the following, the method is explained by way of an example. All values mentioned here are exemplary and do not restrict the solution according to the invention. With a digital resolution of 8-bit, a heating arrangement with a maximum output equal to 8 kW can be controlled in 256 output stages. The consecutive output stages then differ by a value of approximately 31 W with 256 output stages. When fewer output stages are available for controlling the heating output, the consecutive output stages differ by a greater value. The heating arrangement can then be controlled in steps to the heating output equal to 0 W, 31 W, 62 W, 93 W and so forth up to 8 kW. When the limit output of the heating arrangement is set to 4 kW and the heating arrangement is controlled with a digital resolution of 8-bit, the consecutive output stages differ by a value of approximately 15.5 W. The heating arrangement can then be controlled in steps to the heating output equal to 0 W, 15.5 W, 31 W, 46.5 W and so forth up to 4 kW. In this advantageous manner, the heating output can be controlled more finely and accurately which can be advantageous in particular with higher outside temperatures.

In an advantageous further development of the method according to the invention it is provided that the control device compares the received temperature value with a threshold value. When the received temperature value is higher than the threshold value, the control arrangement sets the limit output smaller than the maximum output of the heating arrangement. When the received temperature value is smaller than the threshold value, the control arrangement sets the limit output equal to the maximum output of the heating arrangement. In this way, the heating arrangement can be operated for example in lower outside temperatures with the maximum output and in higher outside temperatures with the limit output that is smaller than the maximum output. Advantageously, the control device can adapt the heating behaviour of the heating arrangement to the outside temperature and to the current heat requirement in the motor vehicle because of this.

Advantageously it can be provided that the control device assigns the received temperature value to one of the multiple predefined temperature ranges. Here, one of the multiple predefined limit outputs corresponds to the respective predefined temperature range. Advantageously, the number of the multiple predefined temperature ranges and the multiple limit outputs can be between 2 and 4. Advantageously it can be provided that the respective predefined limit outputs differ from one another by an equal or unequal value. Alternatively or additionally, the respective predefined limit outputs of the heating arrangement can each amount to a fraction of the maximum output of the heating arrangement.

In a further development of the method it is provided that the control device, with a comparatively high temperature value, determines a comparatively small limit output of the heating arrangement. Here, the comparatively higher temperature value corresponds to a higher outside temperature. In the higher outside temperature, the heating arrangement need not usually be operated with the maximum output and the limit output can be correspondingly smaller. Because of this, the heating output of the heating arrangement, with ever higher outside temperatures, can be ever more finely adjusted and the heating behaviour of the heating arrangement accordingly adapted to the current heat requirement in the motor vehicle.

The invention also relates to a heating arrangement, in particular a PTC heating arrangement, for a hybrid or an electric vehicle. Here, the heating arrangement comprises a control device which is designed for carrying out the method described above. Advantageously, the control device can be a part of the heating arrangement or a part of an air conditioning control for the hybrid or the electric vehicle. The heating arrangement can be an air-side PTC heating arrangement for the hybrid or the electric vehicle.

Further important features and advantages of the invention are obtained from the subclaims, from the drawing and from the associated FIGURE description by way of the drawing.

It is to be understood that the features mentioned above and still to be explained in the following cannot only be used in the respective combination stated but also in other combinations or by themselves without leaving the scope of the present invention.

Preferred exemplary embodiments of the invention are shown in the drawing and are explained in more detail in the following description.

### BRIEF DESCRIPTION OF THE DRAWINGS

The FIGURE shows a schematic sequence of a method for digitally controlling a heating arrangement.

### DETAILED DESCRIPTION

The FIGURE shows a schematic sequence of a method 1 according to the invention for digitally controlling a heating arrangement 2. Here, a control device 3 of the heating arrangement 2 receives a temperature value T₁ or T₂ or T₃, which each reflect a current outside temperature T_{A1}, or T_{A2} or T_{A3}. Dependent on the received temperature value T₁ or T₂ or T₃, the control device 3 then determines a limit output P_{G1} or P_{G2} or P_{G3} of the heating arrangement 2 that is smaller than a maximum output P_{MAX} and higher than the minimum output P_{MIN} of the heating arrangement 2. The control device 3 then divides the determined limit output P_{G1} or P_{G2} or P_{G3} into output stages 4, the number of which corresponds to a digital resolution of the control device 3. In this example, the control device 3 has the digital solution equal to 8-bit. Accordingly, the number of the output stages 4 is equal to 256. Following this, the control device 3 controls the heating arrangement 2 between the minimum output P_{MIN} and the limit output P_{G1} or P_{G2} or P_{G3} to one of the output stages 4. Here, the heating output of the smallest output stage 4 is equal to the minimum output P_{MIN} and equal to zero and the heating output of the highest output stage 4 is equal to the limit output P_{G1} or P_{G2} or P_{G3}.

The temperature value T₁ is below a threshold value T₀, so that the control device 3 sets the limit output P_{G1} equal to the maximum output P_{MAX}. The temperature value T₂ is above the threshold value T₀, so that the control device 3 sets the limit output P_{G2} smaller than the maximum output P_{MAX}. The output stages 4 in this case differ by a smaller value than with the limit output P_{G1}, which is equal to the maximum output P_{MAX}. The temperature value T₃ is above the threshold value T₀ and more over is greater than the temperature value T₂, so that the control device 3 sets the limit output P_{G3} smaller than the maximum output P_{MAX} and smaller than the limit output P_{G2}. In this case, the output stages 4 differ by a smaller value than with the limit output P_{G1} and also P_{G2}.

In the method 1 according to the invention, the heating output of the heating arrangement 2 can be more finely controlled, which can be advantageous in particular in higher outside temperatures.

1. A method for digitally controlling a heating arrangement, comprising:
receiving a temperature value with a control device of the heating arrangement, the temperature value reflecting a current outside temperature;
determining via the control device, based on the received temperature value, a limit output of the heating arrangement that is smaller than a maximum output of the heating arrangement;
dividing the determined limit output into a plurality of output stages via the control device, a number of the plurality of output stages corresponding to a digital resolution of the control device; and
controlling the heating arrangement via the control device between a minimum output and the limit output to one of the plurality of output stages.

2. The method according to claim 1, further comprising:
comparing the received temperature value with a threshold value via the control device;
setting the limit output to be smaller than the maximum output via the control device when the received temperature value is higher than the threshold value; and
setting the limit output equal to the maximum output via the control device when the received temperature value is smaller than the threshold value.

3. The method according to claim 1, further comprising assigning the received temperature value to one of a plurality of predefined temperature ranges via the control device, wherein the determined limit output is one of a plurality of predefined limit outputs which each correspond to a respective predefined temperature range of the plurality of predefined temperature ranges.

4. The method according to claim 3, wherein a number of the plurality of predefined temperature ranges and a number of the plurality of predefined limit outputs is 2 to 4.

5. The method according to claim 3, wherein at least one of:
the plurality of predefined limit outputs differ from one another by one of an equal value and an unequal value; and
the plurality of predefined limit outputs each amount to a fraction of the maximum output of the heating arrangement.

6. The method according to claim 1, wherein, when the control device receives a comparatively high temperature value, a comparatively small limit output of the heating arrangement is determined.

7. The method according to claim 1, wherein the determined limit output is divided into 256 output stages or less corresponding to a digital resolution of 8-bit.

8. A heating arrangement for one of a hybrid vehicle and an electric vehicle, comprising a control device configured to digitally control the heating arrangement via a method including:
receiving a temperature value reflecting a current outside temperature;
determining a limit output of the heating arrangement that is smaller than a maximum output of the heating arrangement based on the received temperature value;
dividing the determined limit output into a plurality of output stages, a number of the plurality of output stages corresponding to a digital resolution of the control device; and
controlling the heating arrangement between a minimum output and the limit output to one of the plurality of output stages.

9. The heating arrangement according to claim 8, wherein one of:
the control device is provided as a component of the heating arrangement; and
the control device is provided as a component of an air conditioning control.

10. The heating arrangement according to claim 8, wherein the heating arrangement is structured as an air-side PTC heating arrangement.

11. The method according to claim 1, wherein the maximum output of the heating arrangement is 3 kW to 8 kW.

12. The method according to claim 2, further comprising assigning the received temperature value to one of a plurality of predefined temperature ranges via the control device, wherein the determined limit output is one of a plurality of predefined limit outputs which each correspond to a respective predefined temperature range of the plurality of predefined temperature ranges.

13. The method according to claim 12, wherein a number of the plurality of predefined temperature ranges and a number of the plurality of predefined limit outputs is 2 to 4.

14. The method according to claim 13, wherein the plurality of predefined limit outputs differ from one another by an equal value and the plurality of predefined limit outputs each amount to a fraction of the maximum output of the heating arrangement.

15. The method according to claim 13, wherein the plurality of predefined limit outputs differ from one another by an unequal value and the plurality of predefined limit outputs each amount to a fraction of the maximum output of the heating arrangement.

16. The method according to claim 2, wherein a comparatively small limit output of the heating arrangement is determined when the control device receives a comparatively high temperature value.

17. The method according to claim 2, wherein the determined limit output is divided into 256 output stages or less corresponding to a digital resolution of 8-bit.

18. The method according to claim 3, wherein the plurality of predefined limit outputs differ from one another by an equal.

19. The method according to claim 3, wherein the plurality of predefined limit outputs differ from one another by an unequal value.

20. The method according to claim 3, wherein the plurality of predefined limit outputs each amount to a fraction of the maximum output of the heating arrangement.
